(19) United States
(12) Patent Application Publication
(10) Pub. No.: US 2018/0212540 A1
(43) Pub. Date: Jul. 26, 2018

(54) IMAGE FORMING APPARATUS, MOTOR CONTROLLER AND METHOD FOR DIAGNOSING FAULT THEREOF

(71) Applicant: S-PRINTING SOLUTION CO., LTD., Suwon-si (KR)

(72) Inventors: Young-jun SHIM, Suwon-si (KR); Yong-ho You, Seoul (KR)

(73) Assignee: S-PRINTING SOLUTION CO., LTD., Suwon-si (KR)

(21) Appl. No.: 15/660,463

(22) Filed: Jul. 26, 2017

(30) Foreign Application Priority Data
Jan. 25, 2017 (KR) 10-2017-0011730

(51) Int. Cl. H02P 6/12; H02P 6/28

(52) U.S. Cl. CPC H02P 6/12; H02P 6/28

(57) ABSTRACT

An image forming apparatus is provided. The image forming apparatus includes an image former configured to perform an image formation; a brushless DC (BLDC) motor configured to start the image former; and a motor controller configured to receive a plurality of driving information from the BLDC motor and to perform a feedback control for the BLDC motor based on at least one of the plurality of received driving information, wherein the motor controller confirms a plurality of error items for the BLDC motor based on the plurality of received driving information.

### CROSS-REFERENCE TO RELATED APPLICATIONS

This application claims priority from Korean Patent Application No. 10-2017-0011730, filed on Jan. 25, 2017, in the Korean Intellectual Property Office, the disclosure of which is incorporated herein by reference in its entirety.

### BACKGROUND OF THE INVENTION

### Field of the Invention

Apparatuses and methods consistent with the present disclosure relate to an image forming apparatus, a motor controller, and a method for diagnosing a fault thereof, and more particularly, to an image forming apparatus, a motor controller, and a method for diagnosing a fault thereof that may detect whether a defect is present and the type of the defect using a signal provided by a blushless DC (BLDC) motor.

### Description of the Related Art

An image forming apparatus is an apparatus that performs generation, printing, reception, transmission, and the like of image data, and representative examples thereof may include a printer, a scanner, a copier, a facsimile, and a multi-function printer (MFP) in which functions thereof are integrally implemented.

Such an image forming apparatus uses motors for performing various functions such as movement of a printing paper, supply of the printing paper, and the like. As it is recently possible to attach option units that perform various functions such as an auto document feeder (ADF) unit, a finisher unit, a high capacity feeder (HCF) unit, and a double capacity feeder (DCF) unit to the image forming apparatus, the number of motors which may be used in the image forming apparatus is gradually increased.

In order to prevent noises generated at the time of driving the image forming apparatus, a brushless DC (BLDC) motor has been recently and widely used. In the BLDC motor, which is a motor that does not include a brush structure in a DC motor and electronically performs rectification, since a mechanical friction part between a brush and a commutator is removed, a speed may increase, a lifespan is increased, and a small amount of noise is generated.

Since the BLDC motor does not include the brush structure as described above, it uses a driving circuit in that position information of a rotor should be sensed using a hall sensor, or the like, and power should be sequentially applied to each phase of the BLDC motor to control the BLDC motor.

However, the conventional driving circuit has only sensed whether the BLDC motor operates according to a target speed, but does not confirm a detail cause when the BLDC motor is not normally operated.

### SUMMARY OF THE INVENTION

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides an image forming apparatus, a motor controller, and a method for diagnosing a fault thereof that may detect whether a defect is present and the type of the defect using a signal provided by a BLDC motor.

According to an aspect of the present disclosure, an image forming apparatus includes an image former configured to perform an image formation; a brushless DC (BLDC) motor configured to start the image former; and a motor controller configured to receive a plurality of driving information from the BLDC motor and to perform a feedback control for the BLDC motor based on at least one of the plurality of received driving information, wherein the motor controller confirms a plurality of error items for the BLDC motor based on the plurality of received driving information.

The error items may include at least one of an over-current error, an overload error, a current sensing error, a hall sensor error, and an FG error.

The motor controller may sense three-phase current values output from the BLDC motor, and confirm an over-current error using the sensed three-phase current values.

The motor controller may sense three-phase current values output from the BLDC motor, calculate a torque value of the BLDC motor using the sensed three-phase current values, and confirm an overload error using the calculated torque value.

The motor controller may confirm a hall sensor error and an FG error, and confirm the overload error when the hall sensor error and the FG error are not present.

The motor controller may sense three-phase current values output from the BLDC motor, calculate a current offset value from the sensed three-phase current values, and confirm a current sensing error using the calculated offset value.

The motor controller may sense signal values of a hall sensor of the BLDC motor, and confirm the hall sensor error depending on whether or not the sensed signal values have an abnormal combination value.

The motor controller may sense signal values of a hall sensor of the BLDC motor, senses a value of an FG sensor of the BLDC motor, and confirm an FG sensor error using the sensed signal values of the hall sensor and the sensed value of the FG sensor.

The motor controller may stop an operation of the BLDC motor, when an error is confirmed in at least one item of the plurality of error items.

The motor controller may stop an operation of the BLDC motor, when an error is repeatedly confirmed over a predetermined number of times for the same error item.

The image forming apparatus may further include a display configured to display the error item, when an error is confirmed in at least one error item of the plurality of error items.

The motor controller may include an inverter configured to provide three-phase voltages to the BLDC motor; a sensor configured to receive a plurality of driving information from the BLDC motor; and a processor configured to perform the feedback control for the BLDC motor based on at least one of the plurality of received driving information, and to confirm the plurality of error items for the BLDC motor based on the plurality of received driving information.

The sensor may include a rotor position sensor configured to receive position information of the rotor from a hall sensor attached to each BLDC motor; a speed sensor configured to receive rotational speed information from each BLDC motor; and a current sensor configured to sense a phase current of the BLDC motor.

The image forming apparatus may further include a step motor; and a DC motor, wherein the motor controller controls at least one of the step motor and the DC motor while controlling the BLDC motor.

According to another aspect of the present disclosure, a motor controller driving a brushless DC (BLDC) motor includes an inverter configured to provide three-phase voltages to the BLDC motor; a sensor configured to receive a plurality of driving information from the BLDC motor; and a processor configured to perform a feedback control for the BLDC motor based on at least one of the plurality of received driving information, and to confirm a plurality of error items for the BLDC motor based on the plurality of received driving information.

According to another aspect of the present disclosure, a method for controlling a brushless DC (BLDC) motor includes driving the BLDC motor by providing phase voltages to the BLDC motor; receiving a plurality of driving information from the BLDC motor; and confirming a plurality of error items for the BLDC motor based on the plurality of received driving information.

The error items may include at least one of an over-current error, an overload current, a current sensing error, a hall sensor error, and an FG error.

In the confirming of the plurality of error items, three-phase current values output from the BLDC motor may be sensed, a torque value of the BLDC motor may be calculated using the sensed three-phase current values, and an overload error may be confirmed using the calculated torque value.

In the confirming of the plurality of error items, the overload error may be confirmed when the hall sensor error and the FG error are not present.

The method may further include displaying the error items, when at least one error item of the plurality of error items is confirmed.

### BRIEF DESCRIPTION OF THE DRAWING FIGURES

The above and/or other aspects of the present disclosure will be more apparent by describing certain exemplary embodiments of the present disclosure with reference to the accompanying drawings, in which:

FIG. 1 is a block diagram illustrating a configuration of an image forming apparatus according to an exemplary embodiment of the present disclosure;

FIG. 2 is a configuration diagram of an image former of FIG. 1 according to an exemplary embodiment;

FIG. 3 is a diagram illustrating an operation a motor controller of FIG. 1;

FIG. 4 is a diagram illustrating a detailed configuration of the motor controller of FIG. 1;

FIG. 5 is a diagram illustrating a fault diagnosis algorithm using a plurality of driving information according to an exemplary embodiment of the present disclosure;

FIG. 6 is a diagram illustrating a method for confirming a current sensing error according to an exemplary embodiment of the present disclosure;

FIG. 7 is a diagram illustrating a method for confirming an over-current error according to an exemplary embodiment of the present disclosure;

FIG. 8 is a diagram illustrating a method for confirming an overload error according to an exemplary embodiment of the present disclosure;

FIG. 9 is a diagram illustrating a structure of a hall sensor;

FIG. 10 is a diagram illustrating state values of the hall sensor;

FIG. 11 is a diagram illustrating a method for confirming a hall sensor error according to an exemplary embodiment of the present disclosure;

FIG. 12 is a diagram illustrating a state diagram of speed measurements of a motor;

FIG. 13 is a diagram illustrating a method for confirming an FG sensor error according to an exemplary embodiment of the present disclosure; and

FIG. 14 is a flowchart illustrating a method for diagnosing a fault according to an exemplary embodiment of the present disclosure.

### DETAILED DESCRIPTION OF THE EXEMPLARY EMBODIMENTS

Hereinafter, various exemplary embodiments of the present disclosure will be described with reference to the accompanying drawings. The exemplary embodiments to be described below may also be modified in various forms. In order to more clearly describe features of the exemplary embodiments, a detailed description of matters known to those to skilled in the art to which the exemplary embodiments belong will be omitted.

Meanwhile, in the present specification, a case in which any component is “connected” with another component includes a case in which any component is ‘directly connected’ to another component and a case in which any component is ‘connected to another component while having the other component interposed therebetween’. In addition, a case in which any component “comprises” another component means that any component may further comprise other components, not exclude other components, unless explicitly described to the contrary.

In the present specification, an “image forming job” may mean various jobs (e.g., a printing, a scan, or a fax) related to an image such as formation of the image or generation/storing/transmission of an image file, and a “job” may refer not only to the image forming job, but also to a series of processes required to perform the image forming job.

In addition, an “image forming apparatus” refers to an apparatus of printing print data generated from a terminal such as a computer on a recoding paper. Examples of the image forming apparatus may include a copier, a printer, a facsimile, a multi-function peripheral (MFP) of complexly implementing functions thereof through a single apparatus, and the like. The image forming apparatus may mean all apparatuses capable of performing the image forming job such as the printer, the scanner, the fax machine, the multi-function printer (MFP) or a display device.

In addition, a “hard copy” may mean an operation of outputting the image to a print medium such a paper, or the like, and a “soft copy” may mean an operation of outputting the image to the display device such as a TV, a monitor, or the like.

In addition, “contents” may mean all kinds of data that are subject to the image forming job, such as photos, images, document files, or the like.

In addition, “print data” may mean data transformed into printable format by the printer. Meanwhile, when the printer supports a direct printing, a file itself may be the print data.

In addition, a “user” may mean a person performing an operation related to the image forming job using the image forming apparatus, or using a device which is connected wired/wirelessly with the image forming apparatus. In addition, a “manager” may mean a person having authority to access all the functions of the image forming apparatus and a system. The “manager” and the “user” may also be the same person.

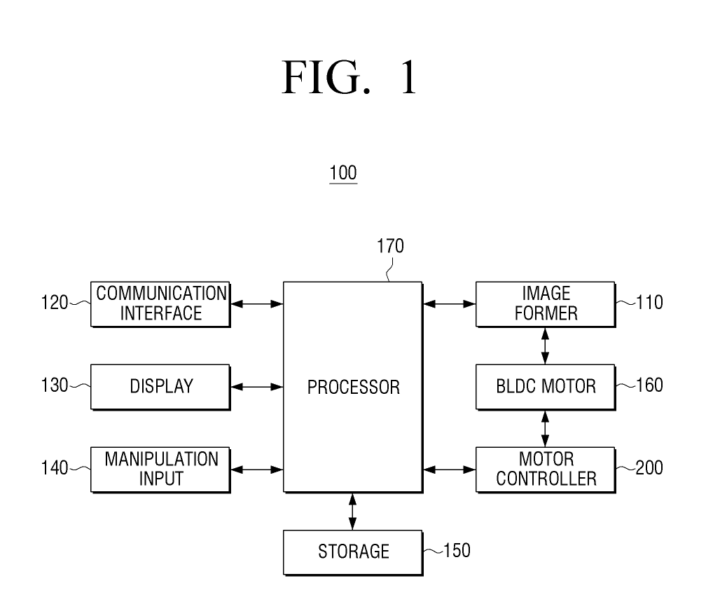

FIG. 1 is a block diagram illustrating a configuration of an image forming apparatus according to an exemplary embodiment of the present disclosure.

Referring to FIG. 1, an image forming apparatus 100 includes an image former 110, a communication interface 120, a display 130, a manipulation input 140, a storage 150, a BLDC motor 160, a processor 170, and a motor controller 200.

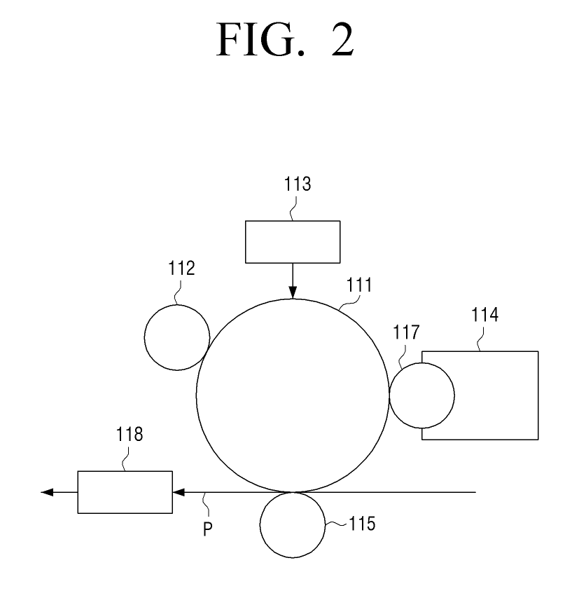

The image former 110 prints print data. Specifically, the image former 110 may print the print data rendered by the processor 170. A detailed configuration of the image former 110 will be described below with reference to FIG. 2.

The communication interface 120 is connected to a print controlling terminal (not shown), and receives the print data from the print controlling terminal. Specifically, the communication interface 120 is formed to connect the image forming apparatus 100 with an external device, and the image forming apparatus 100 may also be connected to the terminal through a local area network (LAN) and an Internet network as well as through an universal serial bus (USB) port or a wireless communication (e.g., WiFi 802.11a/b/g/n, NFC, Bluetooth) port.

The communication interface 120 may notify an external server of a fault fact of the image forming apparatus 100. In this case, the communication interface 120 may simultaneously notify a detailed fault portion. For example, in a case in which the image forming apparatus 100 confirms abnormality of a hall sensor of the BLDC motor, the communication interface 120 may notify a management server (not shown) of a printer, or the like of the abnormality of the hall sensor. Accordingly, the management server of the printer may be notified with a detailed error fact of the image forming apparatus 100, and consequently, additional actions may be performed such as ordering required consumables (e.g., the BLDC motor), calling an A/S engineer, or the like.

The display 130 displays a variety of information provided by the image forming apparatus 100. Specifically, the display 130 may display a user interface window for selecting a variety of functions provided by the image forming apparatus 100. Such a display 130 may be a monitor such as an LCD, a CRT, an OLED, or the like, and may also be implemented as a touch screen that may simultaneously perform a function of the manipulation input 140 to be described below.

In addition, the display 130 may display control menus for performing the functions of the image forming apparatus 100.

In addition, the display 130 may display that an error or fault occurs in the BLDC motor or the motor controller, an occurrence fact of the fault, and a detailed fault cause. For example, in a case in which the hall sensor of the BLDC motor used to operate ADF fails and is not operated, the display 130 may not only notify a fault fact of the scanner, but also display that the hall sensor of the BLDC motor in the scanner has failed.

The manipulation input 140 may receive a function section and a control command for the corresponding function from the user. Here, the function may include a print function, a copy function, a scan function, a fax transmission function, or the like. Such a function control command may be received through the control menu displayed on the display 130.

Such a manipulation input 140 may be implemented as a plurality of buttons, a keyboard, a mouse, or the like, and may also be implemented as the touch screen that may simultaneously perform the function of the display 130 described above.

The storage 150 may store the print data received through the communication interface 120. Such a storage 150 may be implemented as a storage medium in the image forming apparatus 100 and an external storage medium, for example, a removable disk including an USB memory, a storage medium connected to a host, a web server via a network, and the like.

The storage 150 may store a variety of log information related to a driving of the BLDC motor 160. Here, the log information may be a variety of events (e.g., driving start information, whether or not an error occurs, and the like) generated in the BLDC motor.

In addition, the storage 150 may store a variety of set values (e.g., a reference offset value, a reference current value, a reference torque value, a reference speed value) required to determine the fault of the BLDC motor.

The BLDC motor 160 operates the image former 110. Such a BLDC motor may perform a constant velocity or acceleration driving according to a three phase voltage provided by the motor controller 200. Here, the BLDC motor 160 may be a motor for performing various functions of the image forming apparatus, such as driving a photosensitive medium, driving a fixer, transporting a paper, and the like. In addition, although the present exemplary embodiment describes a case in which the BLDC motor 160 is applied to only the image former that prints the image, the BLDC motor 160 may also be a motor of a scanner that scans a script. In addition, although the present exemplary embodiment illustrates only one BLDC motor 160, a plurality of BLDC motors may also be provided in the image forming apparatus at the time of implementation.

The motor controller 200 provides a driving voltage (e.g., the three phase voltage) to the BLDC motor 160 according to the control command. Specifically, the motor controller 200 may receive or obtain a control command of a rotation start/stop, an acceleration/deceleration, a speed instruction value, and the like for the BLDC motor from the processor 170, and generate a phase voltage corresponding to the received control command to provide the generated phase voltage to the BLDC motor 160.

In addition, the motor controller 200 may receive driving information from the BLDC motor, and may perform a feedback control for the BLDC motor based on at least one of a plurality of received driving information (or feedback signals). Here, the feedback control may be a vector control or a field oriented control (FOC) for high precision instantaneous torque control. Here, the driving information, which is information used at the time of feedback control of the BLDC motor, may be a phase current, a hall sensing signal, an FG signal, and the like.

In addition, the motor controller 200 may confirm whether or not a plurality of fault items of the BLDC motor fail based on the plurality of driving information received from the BLDC motor. Here, the fault items may be five items as in Table 1.

TABLE 1

| No. | Fault Name | Contents | Cause |
|---|---|---|---|
| 1 | Current | Disable Current | Faulty of Current Sensing |
| | Sensing | Sensing | Circuit |
| | Fault | | |
| 2 | Over Max | Exceed Maximum | Application of Over-Current to |
| | Current | Current | Motor |
| 3 | Over Max | Exceed Maximum | Overload of Driven Side |
| | Torque | Torque | |
| 4 | Hall Error | Hall Signal Error | Faulty of Hall Element and |
| | | | Sensing Circuit |
| 5 | FG Error | FG Signal Error | Faulty of FG Pattern and |
| | | | Sensing Circuit |

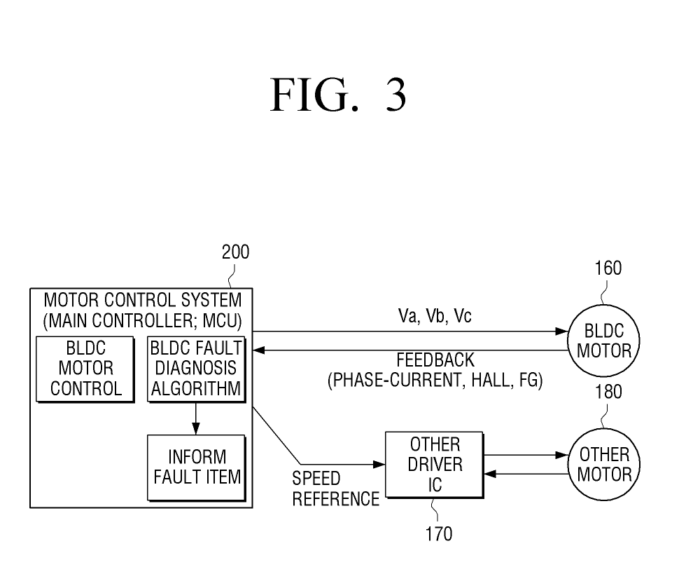

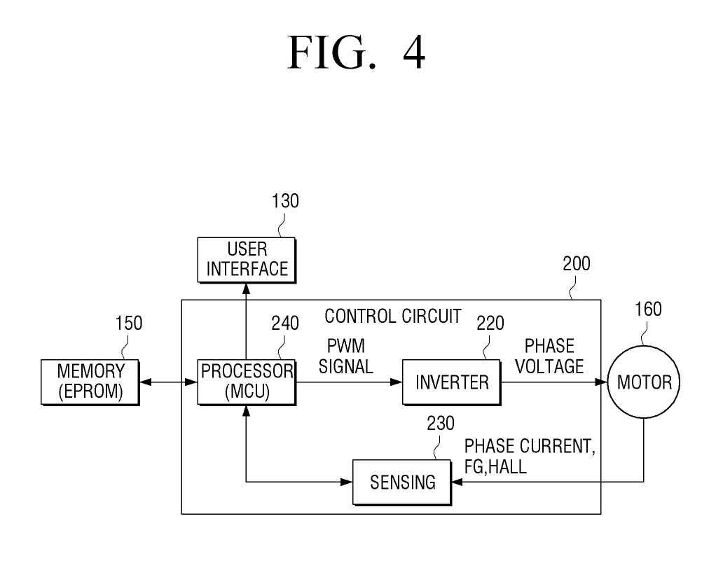

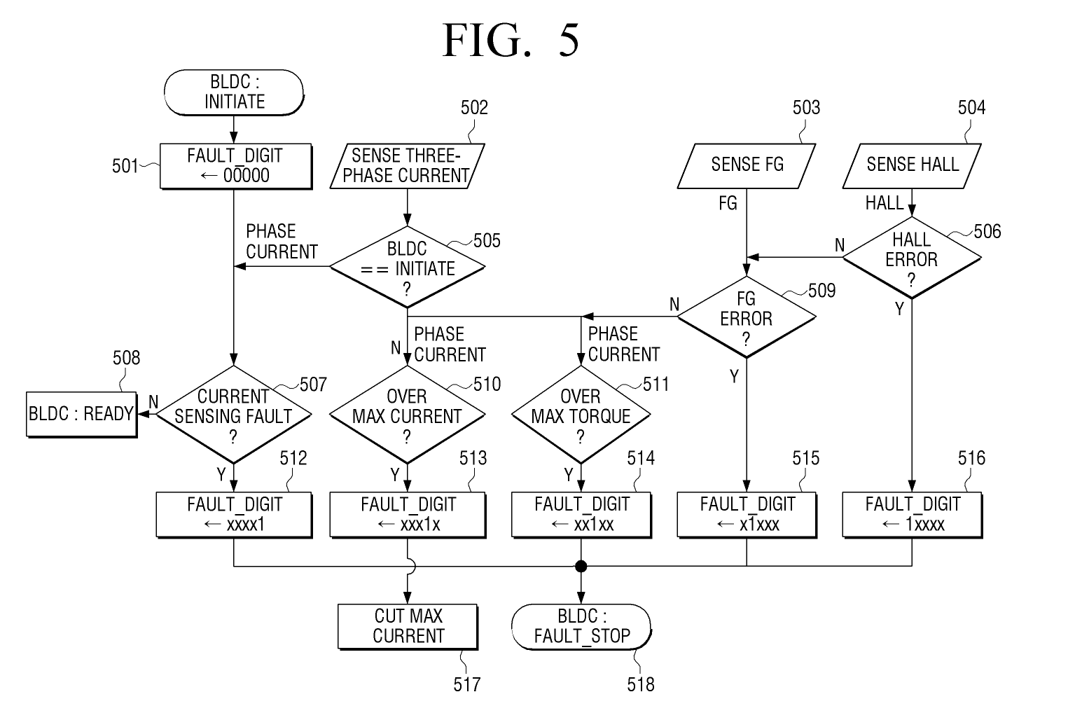

A detailed operation of detecting whether or not the above-mentioned fault occurs using the plurality of driving information will be described below with reference to FIG. 5. In addition, detailed configuration and operation of the motor controller 200 will be described below with reference to FIGS. 3 and 4.

The processor 170 performs a control for each of the components within the image forming apparatus 100. Such a processor 170 may include a CPU, a ROM, a RAM, and the like.

If the processor 170 receives the print data from the print controlling terminal, the processor 170 controls an operation of the image former 110 so that the received print data is printed, and transmits the control command for the BLDC motor 160 of operating the image former 110 to the motor controller 200. For example, the processor 170 may transmit the control command of a rotation start/stop, an acceleration/deceleration/a speed instruction value, and the like for the BLDC motor to the motor controller 200. Meanwhile, although the present exemplary embodiment describes a case in which the processor 170 transmits the control command for the BLDC motor, the image former 110 may also transmit the control command to the motor controller 200 at the time of implementation.

The processor 170 may receive fault information from the motor controller 200, and may perform an action accordingly when the fault information is received. For example, if it is determined that the BLDC motor 160 is operated in an over-current, the process 170 may control the motor controller 200 so that the phase voltage is not temporarily provided. Alternatively, if it is determined that the BLDC motor 160 is operated in an overload, the processor 170 may take action so that the BLDC motor 160 is not operated, and may control the display 130 so that a message requesting the confirmation of a paper jam, or the like is displayed. Alternatively, if a fault of the hall sensor or the FG sensor of the BLDC motor 160 or a fault of the current sensing circuit is confirmed, the processor 170 may control the display 130 so that it is displayed that a repair is required.

Meanwhile, in the above description, although it is described that the motor controller 200 detects the error or fault, and provides the detected error or fault to the processor 170, the motor controller 200 may also be implemented in a form in which the motor controller 200 transmits the driving information required to detect the error or fault to the processor 170, and the processor 170 directly detects the error or fault and takes action, at the time of implementation.

As described above, since the image forming apparatus 100 according to the present exemplary embodiment may confirm a variety of errors and faults related to the driving of the BLDC motor using feedback control factors used at the time of feedback control, it is possible to more appropriately protect a system. Therefore, there are advantages in that whether or not the fault of the motor system occurs may be confirmed, it is possible to determine whether the operation of the motor system is impossible by any cause such as the overload due to the faulty of the driven side, and it is possible to diagnose a detailed fault cause to quickly cope when an abnormal phenomenon occurs.

Meanwhile, hereinabove, although only simple configurations configuring the image forming apparatus have been illustrated and described, various configurations may be additionally included at the time of implementation.

FIG. 2 is a configuration diagram of the image former of FIG. 1 according to an exemplary embodiment.

Referring to FIG. 2, the image former 110 may include a photosensitive drum 111, a charger 112, an exposure machine 113, a developing machine 114, a transfer 115, and a fuser 118.

The image former 110 may further include a feeding means (not shown) for supplying a recording medium P. An electrostatic latent image is formed on the photosensitive drum 111. The photosensitive drum 111 may be referred to as the photosensitive drum, a photosensitive belt, or the like depending on a form thereof. Such a photosensitive drum 111 may be operated by the BLDC motor described above.

Hereinafter, for convenience of explanation, only a configuration of the image former 110 corresponding to one color will be described by way of example, but at the time of implementation, the image former 110 may include a plurality of photosensitive drums 111, a plurality of chargers 112, a plurality of exposure machines 113, and a plurality of developing machines 114 that correspond to a plurality of colors.

The charger 112 charges a surface of the photosensitive drum 111 with a uniform potential. The charger 112 may be implemented in a form of a corona charger, a charge roller, a charge brush, or the like.

The exposure machine 113 forms the electrostatic latent image on the surface of the photosensitive drum 111 by changing a surface potential of the photosensitive drum 111 according to image information to be printed. As an example, the exposure machine 113 may form the electrostatic latent image by irradiating light modified according to the image information to be printed to the photosensitive drum 111. This type of exposure machine 113 may be referred to as a light scanner, and an LED may be used as a light source.

The developing machine 114 accommodates a developer therein, and supplies the developer to the electrostatic latent image to develop the electrostatic latent image into a visible image. The developing machine 114 may include the developing roller 117 that supplies the developer to the electrostatic latent image. For example, the developer may be supplied to the electrostatic latent image formed on the photosensitive drum 111 from the developing roller 117 by a developing electric field formed between the developing roller 117 and the photosensitive drum 111.

The visible image formed on the photosensitive drum 111 is transferred to the recording medium P by the transfer 115 or an intermediate transfer belt (not shown). The transfer 115 may, for example, transfer the visible image to the recording medium by an electrostatic transfer method. The visible image is attached to the recording medium P by electrostatic attraction.

The fuser 118 fuses the visible image on the recording medium P by applying heat and/or pressure to the visible image on the recording medium P. A printing job is completed by a series of processes as described above.

Since the above-mentioned developer is used whenever an image forming job is performed, the developer becomes exhausted when it is used for a predetermined time or more. In this case, a unit (for example, the above-mentioned developing machine 114) itself for storing the developer needs to be newly replaced. As such, replaceable parts or components during the usage of the image forming apparatus are called consumable units or replaceable units. In addition, such a consumable unit may be attached with a memory (or a CRUM chip) for proper management of the corresponding consumable unit.

FIG. 3 is a diagram illustrating an operation the motor controller of FIG. 1.

Referring to FIG. 3, the motor controller 200 provides phase voltages Va, Vb, and Vc to the BLDC motor 160, and receives feedback information (phase-current, hall, FG). In addition, the motor controller 200 may perform a feedback control for the BLDC motor 160 based on the received feedback information.

Specifically, in order to control an electric motor or the motor, a speed control/position control is generally used, and in order to perform a precision control and an instantaneous torque control, a control technique called a vector control or a field oriented control (FOC) is also used.

Meanwhile, a three-phase BLDC motor is widely used in a motor system due to various causes such as high reliability, easiness of control, and the like. The BLDC motor generally has a structure having a rotor including a permanent magnet and a stator including a coil, and is also referred to as a PMSM due to a structure similar to a permanent magnet synchronous motor (PMSM).

Meanwhile, according to the related art, in order to perform the feedback control at the time of driving the BLDC motor, various feedback signals are received from the BLDC motor. According to the related art, however, only whether or not the motor is normally operated is determined by measuring a speed of the motor using the various feedback signals. Therefore, when a fault occurs in the motor system, it was difficult to detect a clear cause, and it took a lot of time to repair the fault.

For example, if an abnormal value different from an actual current value is sensed in sensing a three-phase current value of the motor when performing the vector control, the motor vibrates and the over-current is introduced into the circuit, which may cause a shock to a circuit element. In addition, if a hall signal of the motor is abnormal, the motor possibly vibrates, and there is a possibility that the over-current is introduced into the motor and the motor does not output a normal torque. As such, in order to find detailed causes causing a complex abnormal phenomenon at the time of fault occurrence in the motor system, it takes a lot of time and cost.

In addition, a hardware fault of the motor or the control circuit in the BLDC motor system also causes abnormal operations such as a stop, a vibration, a diverging phenomenon, and like of the motor, and in the worst case, it also cause the circuit element to be burned due to the introduction of the over-current. Such a fault of the motor system leads to operation disable of a higher level system such as a printing system. Therefore, a function of diagnosing the fault of the motor system is an essential element for protecting the control circuit and protecting the higher level system.

In order to solve the above-mentioned problem according to the related art, according to the present disclosure, the higher level system is protected by determining a detailed fault occurrence portion and quickly taking action using the plurality of feedback signals used at the time of performing an existing feedback control. To this end, according to the present disclosure, the detailed fault portion is detected using the three-phase current, the FG signal, and the hall signal, which are the feedback signals of the motor which are used as existing motor control factors.

In addition, the motor controller 200 according to the present exemplary embodiment may also control an additional motor such as a DC motor or a step motor using an additional driving IC, rather than the BLDC motor 160.

The BLDC motor 160, which is a BLDC motor included in the image forming apparatus, receives three-phase voltages which are sequentially received, and may perform a constant speed or acceleration driving according to the received three-phase voltages. In addition, a first motor 700 may perform a forward driving or a backward driving according to a phase order of the received three-phase voltages.

In addition, the BLDC motor 160 may include a hall sensor sensing a position of the rotor in the motor and a speed sensing sensor sensing a rotational speed. Specifically, the hall sensor is a sensor which is attached to the BLDC motor to sense the position of the rotor in the DC motor, and the speed sensing sensor is a sensor outputting driving speed information of the BLDC motor in a form of frequency. The rotor position information and the driving speed information sensed by the hall sensor and the speed sensing sensor may be provided to a sensor 230 in the motor controller 200.

In describing FIG. 3, the motor controller 200 capable of controlling two channels is described, but the motor controller 200 may be implemented in a form supporting three channels or more, and may also be implemented in a form of controlling only a plurality of BLDC motors.

FIG. 4 is a diagram illustrating a detailed configuration of the motor controller of FIG. 1.

Referring to FIG. 4, the motor controller 200 may include an inverter 220, a sensor 230, and a processor 240.

The inverter 220 generates three-phase voltages according to driving signals (PWM signals) provided from the processor 240 and provides the generated three-phase voltages to the BLDC motor 160. Specifically, the inverter 220 includes switching elements corresponding to the number of phases of the BLDC motor, and sequentially performs a switching on/off operation according to the PWM signals provided from the processor 240. As the respective switch elements sequentially perform the switching on/off operation, the BLDC motor 160 receives the three-phase voltages which are sequentially switched on/off.

The sensor 230 may sense the driving information of the BLDC motor 160. Specifically, the sensor 230 may include a rotor position sensor, a speed sensor, and a current detector.

The rotor position sensor may receive position information of the rotor from the hall sensor attached to the BLDC motor, and may provide the received position information to the processor 240.

The speed sensor may receive rotational speed information of the BLDC motor in a form of frequency from the speed sensing sensor (e.g., the FG sensor) attached to the BLDC motor, and may transmit the received rotational speed information of the frequency form to the processor 240. Although the present exemplary embodiment describes the case in which the rotational speed information is sensed using the speed sensing sensor attached to the BLDC motor, the speed may also be sensed according to the position of the rotor sensed by the rotor position sensor described above at the time of implementation.

In addition, the current detector may sense amplitude of an output current of the BLDC motor 160. Specifically, the current detector may sense amplitude of a phase current of the BLDC motor using resistance.

The processor 240 receives a digital control command from the processor 170, and controls the inverter 220 and the sensor 230 so that the BLDC motor 160 is operated according to the received digital control command. Such a processor 240 may be implemented as a circuit such as MCU, ASIC, or the like including ADC.

Specifically, the processor 240 receives the digital control command used to control the operation of the BLDC motor from the processor 170 or the image former 110. Here, the digital control command includes information such as a rotation start/stop, an acceleration/deceleration, a rotation direction, a rotational speed, a break operation, and the like for the BLDC motor. Such a digital control command may be received from the processor 170 or the image former 110 through a universal asynchronous receiver/transmitter (UART), which is a universal asynchronous receiving/transmitting mode, a serial peripheral interface (SPI), which is an interface that allows data to be exchanged by serial communication between two devices, and a serial communication interface such as I2C, which is a bidirectional serial bus, or the like.

The processor 240 reads out a control signal from the received digital control command, and controls the inverter 220 and the sensor 230 so that the BLDC motor 160 is operated according to the read control signal. Specifically, in a case in which the motor controller 200 controls a plurality of motors such as a plurality of BLDC motors or other motors, the processor 240 may read out channel information and a variety of driving commands (e.g., the rotation start/stop, the acceleration/deceleration, the rotation direction, the rotational speed, and the break operation) for the motor to be transmitted to the corresponding channel from the received digital control command through SCLK, SDATA, and SLE terminals, and may transmit the read control signal to a driving controller corresponding to the corresponding channel.

The processor 240 may control the BLDC motor 160 according to the transmitted control signal and the feedback signals sensed by the sensor 230. Specifically, the processor 240 may generate a three-phase driving signal (PWM signal) for the BLDC motor 160 according to the control signal and the rotor position information.

The processor 240 confirms a plurality of error items for the BLDC motor according to the plurality of received feedback signals. In addition, if the processor 240 confirms the error, the processor 240 may store the confirmed error item in the storage 150, or control the display 130 so that the confirmed error item is displayed. Meanwhile, the above-mentioned operation may also be directly performed by the processor 240, but may also be performed by a higher level processor 170. Meanwhile, although the present exemplary embodiment describes a case in which the processor in the image forming apparatus 100 and the processor in the motor controller 200 are different from each other, the above-mentioned two processors may also be implemented in a single processor at the time of implementation.

Hereinafter, a method for controlling a speed and a method for diagnosing a fault in the motor controller 200 will be described using a detailed configuration of the motor controller 200.

First, if the processor 240 generates three-phase driving signals according to the control command (e.g., the motor start), the inverter 220 generates phase voltages corresponding to the generated three-phase driving signals and provides the generated phase voltages to the BLDC motor 160. Accordingly, the BLDC motor 160 receives the phase voltages, and generates currents corresponding to the phase voltages and is rotated. In addition, the hall signal, the FG signal, and the phase current are provided to the processor 240 through the sensor 230 according to the start of the BLDC motor 160.

Meanwhile, the three-phase currents output from the BLDC motor 160 may be classified into an i_{q} current contributing to a torque and an i_{d} current contributing to a magnetic flux through a coordinate transformation, and the i_{q} current has a proportional relationship with the torque as in Mathematical expression 1 below.

TₑK_{T}i_{q} [Mathematical expression 1]

Wherein Tₑ denotes torque of the BLDC motor, i_{q} denotes a current contributing to the torque, and Kₜ denotes a torque constant.

Therefore, the processor 240 may know an instantaneous torque value of the BLDC motor using the sensed phase current, and the processor 240 may also perform an instantaneous torque control using the instantaneous torque value.

In addition, in a case in which the process 240 accurately knows the position of the rotor of the motor and senses an accurate current, the processor 240 may know an output state of the BLDC motor using the i_{q} current because the i_{q} current fully contributes to the torque.

Meanwhile, the processor 240 may receive an FG pulse signal from the sensing circuit, measure a frequency of a pulse, transform the frequency into the speed, and utilize the speed as a factor of the controller.

In addition, the processor 240 may receive a feedback of the signal transformed into the pulse by a three-phase hall element from the motor and the related circuit, calculate an absolute position of the motor, and output a voltage instruction of an appropriate phase corresponding to the absolute position to the inverter. In addition, the processor 240 may also calculate the speed of the motor by a method such as a speed transformation of FG using the pulse provided from the hall element in a low speed band in which the FG pulse does not occur.

Meanwhile, according to the present disclosure, the above-mentioned feedback signals are used to not only perform the feedback control of the BLDC motor, but also to use confirm the fault for the BLDC motor or the controller thereof. The method for diagnosing the fault using the plurality of feedback signals will be described below with reference to FIG. 5.

As described above, since the motor controller 200 according to the present exemplary embodiment may confirm a variety of errors and faults related to the driving of the BLDC motor using the feedback control factors used at the time of feedback control, it is possible to more appropriately protect a system. Therefore, there are advantages in that whether or not the fault of the motor system occurs may be confirmed, it is possible to determine whether the operation of the motor system is impossible by any cause such as the overload due to the faulty of the driven side, and it is possible to diagnose a detailed fault cause to quickly cope when an abnormal phenomenon occurs.

Meanwhile, although it is illustrated and described that the motor controller 200 is a component within the image forming apparatus 100 in describing FIGS. 1 to 4, the motor controller 200 may be implemented as a separate apparatus different from the image forming apparatus 100, and any apparatus may be used other than the image forming apparatus 100 as long as it includes the BLDC motor.

FIG. 5 is a diagram illustrating a fault diagnosis algorithm using a plurality of driving information according to an exemplary embodiment of the present disclosure.

Referring to FIG. 5, the processor 240 may diagnose a detailed fault using the plurality of feedback signals used when performing the motor control.

Since there are no other faults in an initial state, an index indicating the fault is set to a value of ‘0’ (501). In addition, a phase current value may be confirmed from the three-phase current (502).

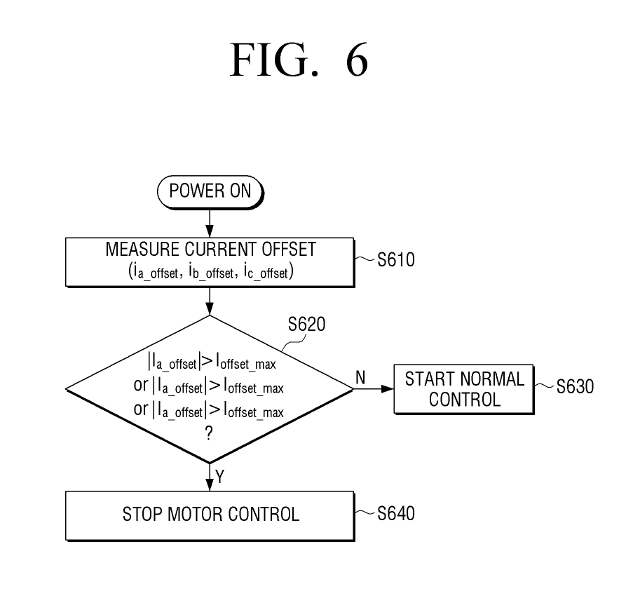

If a current operation state of the BLDC motor is the initial state (505), whether or not an error of the current sensing circuit is present may be confirmed (507). Specifically, if the BLDC motor is in the initial state, there should be no phase current, but no predetermined current value. Therefore, whether or not the error of the current sensing circuit is present may be confirmed by comparing the confirmed phase current value with a predetermined offset value (508, 512). A detailed operation thereof will be described below with reference to FIG. 6.

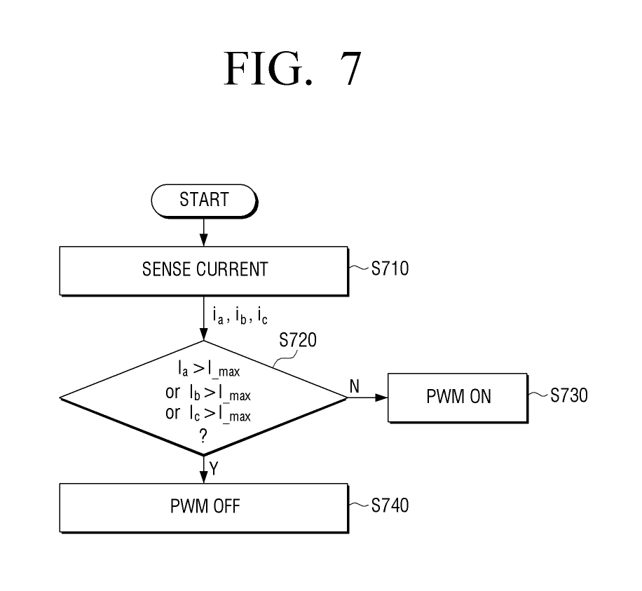

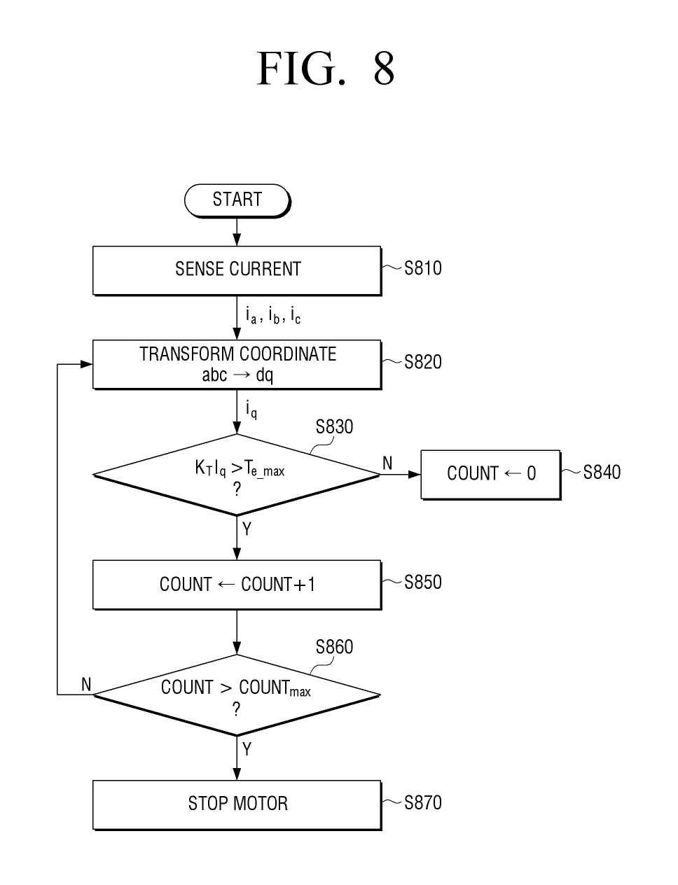

In addition, if the operation state of the BLDC motor is not the initial state, it may be determined whether or not the operation state is an over-current state, or an over-torque state using the sensed current value (510, 512). As a result of determination, if the operation state is the over-current state or the over-torque state, an error state value may be recorded (513, 514). Meanwhile, the operation of determining whether or not the operation state of the BLDC motor is the over-current state or the over-torque state will be described below with reference to FIGS. 7 and 8. Whether or not such an over-current or over-torque is present may be determined in a case in which there is no error in the hall sensor, the FG sensor, or the like.

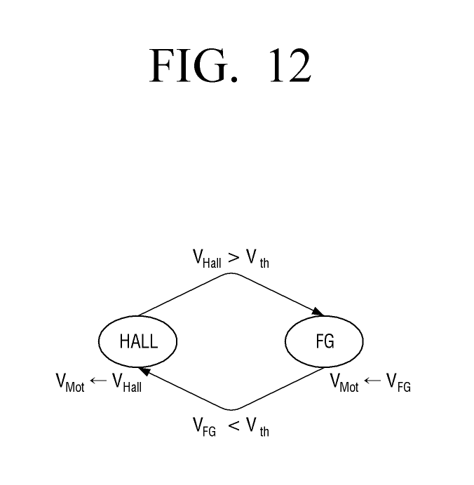

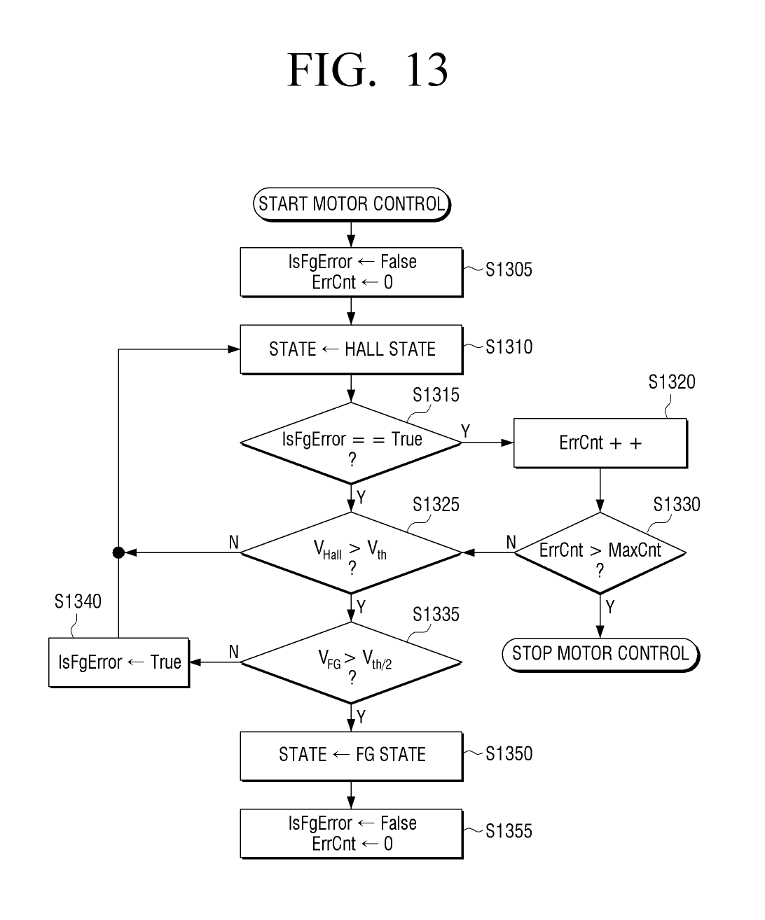

In addition, if the FG signal is received, whether or not an error of the FG sensor or a measurement circuit of the FG sensor is present may be determined according to the received FG signal (509). As a result of determination, if the FG signal is in an error state, the error state may be recorded (515). Whether or not the error of the FG sensor is present may be performed in a case in which the error of the hall sensor is not confirmed. An operation of determining whether or not the error of the FG sensor is present will be described below with reference to FIGS. 12 and 13.

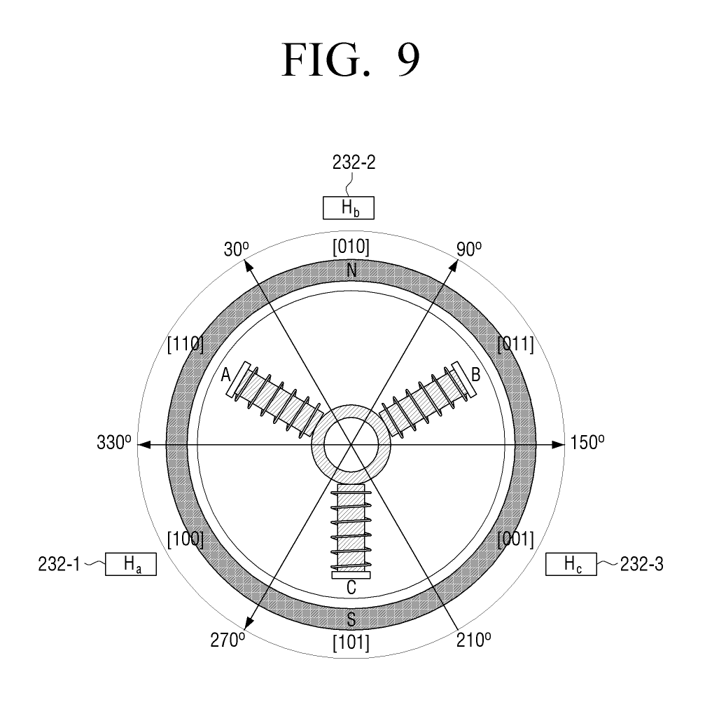

In addition, if the hall signal is received, whether or not an error of the hall sensor or a measurement circuit of the hall sensor is present is determined according to the received hall signal (506). As a result of determination, if the hall sensor is in the error state, the error state is recorded (516). Whether or not the error of the hall sensor is present will be described below with reference to FIGS. 9 to 11.

In addition, if the above-mentioned error is determined, an action corresponding to each error may be immediately performed. In addition, such actions may be different from each other for each of the errors. In addition, at the time of implementation, the above-mentioned action may be immediately performed at the time of sensing one error, but the action may also be performed only in the case in which the same error repeatedly occurs.

FIG. 6 is a diagram illustrating a method for confirming a current sensing error according to an exemplary embodiment of the present disclosure.

In performing a current control during a motor driving control, an accurate sensing of a phase current is directly related to control performance. If the phase current may not be sensed, the over-current occurs or it is impossible to smoothly control a speed/torque. Such a phase current is measured through the sensing circuit and an ADC channel of the processor (MCU), and if a problem occurs in the sensing circuit, an accurate current may not be read. Therefore, a process of determining whether or not the current sensing is normally operated is required at the initial time of booting the processor (MCU).

Such an operation will be described below with reference to FIG. 6.

Referring to FIG. 6, after being turned-on, the processor 240 may measure an initial ADC sensing offset through the current sensing (S610). Whether or not the current sensing is normally operated may be performed immediately after the processor 240 is initially turned on or after an initialization of the control system. Specifically, since an output from the processor 240 does not occur, an initial current needs to be measured at an offset near ‘0’, but if the sensing circuit is abnormal, the offset is measured to a value other than ‘0’.

Therefore, if the sensed current value is greater than a reference offset current I_{offset}_{_}ₘₐₓ, which is an allowable range, then it is determined that the sensing circuit is abnormal (Yes in S620), and the motor control stops (S640).

On the other hand, if the sensed current value is smaller than the reference offset current I_{offset}_{_}ₘₐₓ, which is the allowable range, then it is determined that the sensing circuit is normal (No in S620), and the motor control may start (S630).

Here, a method for measuring the offset of the phase current may be performed after the initialization of the system and before the processor 240 starts the motor control, that is, when a voltage applied to the motor is ‘0’. In addition, the three-phase current value sensed in a control period may be accumulated in a plurality of times in an internal memory of the processor 240, and an average value obtained by dividing the accumulated value by the accumulated number may be used.

FIG. 7 is a diagram illustrating a method for confirming an over-current error according to an exemplary embodiment of the present disclosure.

In a section in which a sudden speed change occurs, such as when the motor starts driving at a stopped state or when the motor suddenly stops, the current also rapidly increases to instantaneously generate a high torque. In this case, since the increased current is a normal operation by the control, but an excessively high current may shock the circuit component, it is necessary to protect the system by limiting a proper amount or more of current.

Such an operation will be described below with reference to FIG. 7.

Referring to FIG. 7, the processor 240 may sense the three-phase current in a current control period to confirm the over-current of the motor in real time (S710). Here, the current control period may be 10 to 20 kHz, and may be equal to a PWM period.

In addition, the sensed current value may be compared with a predetermined reference current value i_max (S720).

As a result of comparison, if the sensed current value is smaller than the predetermined reference current value (No in S720), a normal operation may be continued (S730).

On the contrary, if the sensed current value is greater than the predetermined reference current value (Yes in S720), the processor 240 may naturally protect the output of the inverter by turning off the PWN signal, which is the output instruction to the inverter, thereby making it possible to block a voltage/current supplied to the BLDC motor (S740). In addition, the processor 240 again senses three-phase current in the current control period, and if the sensed current value is smaller than the reference current value, the processor 240 turns on the PWM signal and supplies the current to the motor, thereby making it possible to generate the output.

Since the corresponding function does not stop the motor, limits only the over-current, and enables a smooth control, it transparently operates to the user. The corresponding function may be informed to the user through the display as needed.

FIG. 8 is a diagram illustrating a method for confirming an overload error according to an exemplary embodiment of the present disclosure.

In a case in which the overload abnormally occurs in a motor shaft of the motor system, the motor generates a higher output to overcome the load and rotate. In this case, if an excessive current is generated for a long time, damage of a motor coil and damage of a permanent magnet may be caused. Therefore, the output of the motor is sensed in real time, and the load which is higher than a design load occurs for a long time, it is necessary to protect the system by stopping the motor.

Such an operation will be described below with reference to FIG. 8.

Referring to FIG. 8, the processor 240 may confirm the phase current in the current control period (S810). Here, the current control period may be 10 to 20 kHz.

In addition, a torque value may be calculated by performing a coordinate transformation for the sensed three-phase currents (S820). Specifically, the sensed phase currents may be calculated as the torque value as in Mathematical expressions 2 and 3 below.

In the following Mathematical expression, iₐ, i_{b}, and i_{c} mean the three-phase currents, and may be used by transforming it to i_{q} (=i_{qse}) through the coordinate transformation and again transforming it to the torque value through multiplication with a torque constant K_{T}.

$${i}_{dss} = {i}_{a} \\ {i}_{qss} = ( {i}_{b} - {i}_{c} ) \frac{1}{\sqrt{3}} \qquad [ Mathematical expression 2 ]$$

Here, iₐ, i_{b}, and i_{c} are the phase currents of the respective sensed phases (a, b, c), and i_{dss} and i_{qss} are parameters.

i_{dse}=i_{dss} cos θ+i_{qss} sin θ

i_{qse}=i_{qss} cos θ−i_{dss} sin θ [Mathematical expression 3]

Here, i_{dse} is a current component contributing to a magnetic flux, and i_{qse} is a current component contributing to a torque.

If the torque value is calculated, the calculated torque value K_{T}I_{q} may be compared with a reference torque value Tₑ_{_}ₘₐₓ (S830).

As a result of comparison, if the calculated torque value K_{T}I_{q} is smaller than the reference torque value Tₑ_{_}ₘₐₓ (No in S830), this means a normal state, so a counter value may be set to 0 (S840).

On the contrary, if the calculated torque value K_{T}I_{q} is greater than the reference torque value Tₑ_{_}ₘₐₓ (Yes in S830), the counter value may increase because of the overload state (S850).

In addition, the counter value may be compared with a predetermined counter value countₘₐₓ (S860). Here, the predetermined counter value countₘₐₓ may be a value obtained by dividing a maximum overload hold time by the current control period.

As a result of comparison, if the counter value is greater than the predetermined counter value (Yes in S860), the operation of the motor may be stopped because of a state in which the overload state is continuously maintained (S870). In addition, when the processor 240 confirms the overload through the above-mentioned processes, the processor 240 may display that the overload occurs in the driven side through the display.

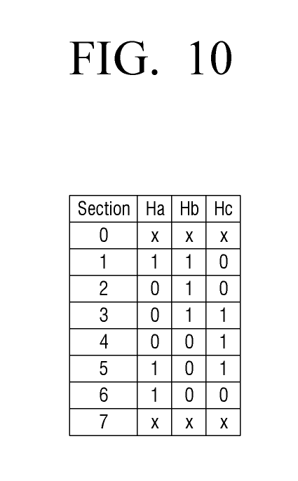

FIG. 9 is a diagram illustrating a structure of a hall sensor and FIG. 10 is a diagram illustrating state values of the hall sensor.

Referring to FIG. 9, the BLDC motor uses three hall signals as illustrated, and the three hall signals have a phase difference of 120 degrees and have pulse outputs of high/low.

If the hall signals are abnormal, an electrical absolute position of the rotor of the motor may not be known, so a voltage having a wrong phase is applied to the motor. In this case, the motor vibrates, and the output and efficiency of the motor are rapidly decreased.

Each hall element is indicated by a value of ‘1’ or ‘0’, and the value is changed according to the rotation of the motor. The positions of the motor which may be indicated using the hall element are eight, which is 23, but there is no case in which all of the hall elements are turned on (000) or turned off (111), the positions of the motor may be indicated by six sections as illustrated in FIG. 10.

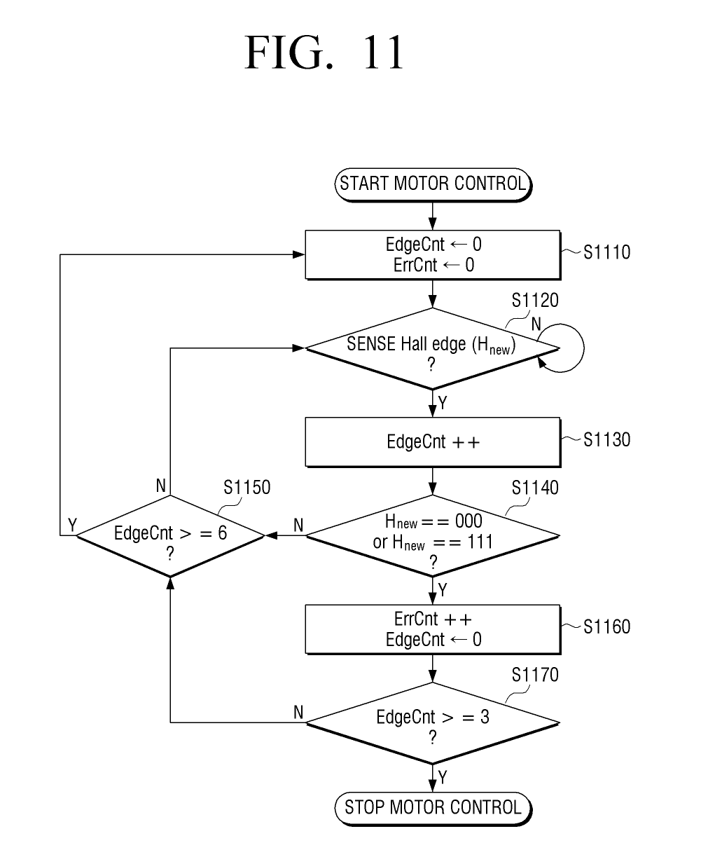

Referring to the sections of FIG. 10, a case in which the hall signal has a value of ‘000’ or ‘111’ means that the hall sensor is abnormal, or the sensing circuit sensing the output of the hall sensor has failed. However, in a case in which the BLDC motor rotates at high speed, since the sensed hall signal may temporarily sense the value of ‘000’ or ‘111’, it may be confirmed that a hall sensor error occurs in a case in which the above-mentioned value is continuously sensed as described below. This will be described below with reference to FIG. 11.

FIG. 11 is a diagram illustrating a method for confirming a hall sensor error according to an exemplary embodiment of the present disclosure.

Referring to FIG. 11, EdgeCnt and ErrCnt may be first initialized (S1110). Here, EdgeCnt is a counter value when a change of the hall signals is sensed and a change of the section occurs, and ErrCnt is a counter value when a combination of the hall signals is ‘000’ or ‘111’.

If the change of the hall signals is confirmed after the initialization (S1120), the value of EdgeCnt may increase (S1130). It may be confirmed whether or not the sensed hall signal has the value of ‘000’ or ‘111’ that may not be generated (S1140).

As a result of confirmation, if there is no abnormality (No in S1140), it may be determined whether or not the counter of the EdgeCnt value is 6 or more (S1150). If the EdgeCnt value is 6 or more (Yes in S1150), the above-mentioned initialization operation is again performed (S1110), and if the EdgeCnt value is less than 6 (No in S1150), the method may proceed to the operation of confirming the change of the hall signal (S1120).

Meanwhile, if the sensed hall signal has the value of ‘000’ or ‘111’ that may not be generated (Yes in S1140), the ErrCnt value may increase, and the EdgeCnt value may be initialized (S1160). In addition, it may be determined whether or not the ErrCnt is 3 or more (S1170).

As a result of determination, if the ErrCnt is 3 or more (Yes in S1170), it may be determined that the hall sensor is abnormal. On the contrary, if the ErrCnt is less than 3 (No in S1170), the method may proceed to the operation of confirming whether or not the counter of the EdgeCnt value is 6 or more (S1150).

The case in which three or more errors occur may be confirmed as the error of the hall sensor through the operations as described above. Here, the above-mentioned constant 3, which is an arbitrary value, may be changed and adopted at the time of implementation, and the constant 6 means the number of times that the hall signal rotates 6 sections one period.

FIG. 12 is a diagram illustrating a state diagram of speed measurements of a motor.

FG is assumed as a tool for measuring the rotational speed of the BLDC motor. The FG generates the same number of pulses every time the motor mechanically makes one revolution, and measures an interval between the pulse and the pulse in terms of time and converts the interval into the speed.

The FG may be used to measure the speed of the motor at low cost, but since it does not generate the pulse at low speed due to its nature, there is a disadvantage in that the FG may be only used at a predetermined speed or more. Therefore, according to the present disclosure, it is assumed that the FG is only used at a predetermined speed Vₜₕ or more, and the speed of the motor is measured using Hall at the predetermined speed Vₜₕ or less.

Referring to FIG. 12, the speed measurements states includes a hall state and an FG state.

Since the speed of the motor is ‘0’ when the motor starts the driving, the speed measurement state starts from the hall state, but when the speed is a reference speed or more as the speed increases, the speed measurement state is switched to the FG state. When the speed measurement state is switched to the FG state, the speed measurement is performed using V_{FG}. In addition, when the speed of the motor becomes less than the reference speed in the FG state, the speed measurement state is again switched to the hall state, and the hall speed according to the hall signal is used. Here, if the FG is inoperable, the motor vibrates and performs an abnormal operation, which may damage a higher level system.

FIG. 13 is a diagram illustrating a method for confirming an FG sensor error according to an exemplary embodiment of the present disclosure.

Referring to FIG. 13, IsFgError may be initially set to false, and ErrCnt may be set to 0 (S1305). The ErrCnt is a counter value of a case in which it is determined that the FG is abnormal.

In addition, since the speed measurement state is the hall state at the time of initial driving, the speed of the motor may be measured using the hall signal (S1310).

In addition, it may be confirmed whether or not the IsFgError is true (S1315). Since the false is initially set (No in S1315), it may be determined whether or not the speed of the hall signal is a reference speed or more (S1325), which is a next operation.

As a result of determination, if the speed of the hall signal is less than the reference speed (No in S1325), the above-mentioned operations may be repeated until the speed of the hall signal becomes the reference speed or more.

In addition, if the speed of the hall signal is gradually increased and exceeds the reference speed Vₜₕ, which is an FG valid section (S1335), the speed measurement state needs to be changed to the FG state, but before the change to the FG state, it may be confirmed whether or not a speed V_{FG} of the FG sensor is greater than V_{th/2} (S1335).

If the speed of the FG sensor is greater than V_{th/2} (Yes in S1335), the speed measurement state may be changed to the FG state and the speed may be measured using the FG signal (S1350).

On the contrary, if the speed of the FG sensor is smaller than V_{th/2} (No in S1335), it may be determined that the FG is abnormal and the IsFgError may be changed to true (S1340).

Meanwhile, since the case in which the speed measurement state is transitioned to the FG state once means that the FG pulse is normally operated, it is possible to prevent a wrong determination of error by initializing the IsFgError to ‘false’ and initializing the ErrCnt to ‘0’ (S1355).

Meanwhile, if the IsFgError is changed to true (Yes in S1315), the ErrCnt may increase (S1320), and it may be determined whether or not the ErrCnt is MaxCnt or more (S1330). Here, the MaxCnt, which is a predetermined reference counter value, may be a value obtained by dividing the error hold time set by the user by the current control period.

As a result of determination, if the ErrCnt is greater than the MaxCnt (Yes in S1330), it may be determined that the FG fails and the motor control may be stopped. In addition, it may be displayed that the FG fails.

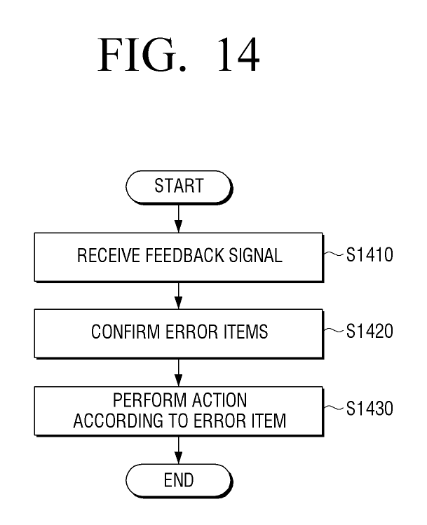

FIG. 14 is a flowchart illustrating a method for diagnosing a fault according to an exemplary embodiment of the present disclosure.

Referring to FIG. 14, the BLDC motor is driven by providing the three-phase voltages to the BLDC motor according to the control command. A plurality of driving information are received from the BLDC motor according to the driving of the BLDC motor (S1410). Here, the plurality of driving information, which are feedback information provided from the BLDC motor, may be a phase current, a hall sensor signal, and an FG signal.

In addition, a plurality of error items for the BLDC motor are confirmed based on the plurality of received driving information (S1420). Specifically, an error for each of the plurality of error items or whether or not a fault occurs may be confirmed using the fault diagnosis algorithm described above for the plurality of received driving information. Here, the error items may include an over-current error, an overload error, a current sensing error, a hall sensor error, and an FG error.

For example, the three-phase current values output from the BLDC motor may be sensed, and the over-current error may be confirmed using the sensed three-phase current values. In addition, the torque value of the BLDC motor may be calculated using the sensed three-phase voltages, and the overload error may also be confirmed using the calculated torque value. In this case, whether or not the overload error occurs may be performed after the hall sensor error and the FG error are confirmed in advance. In addition, a current offset value may be calculated from the sensed three-phase current values, and the current sensing error may be confirmed using the calculated offset value.

In addition, the signal values of the hall sensor of the BLDC motor may be sensed, and the hall sensor error may be confirmed depending on whether or not the sensed signal values have an abnormal combination value. In addition, the signal values of the hall sensor of the BLDC motor may be sensed, a value of the FG sensor of the BLDC motor may be sensed, and the FG sensor error may be confirmed using the sensed signal values of the hall sensor and the sensed value of the FG sensor.

In addition, of at least one error of the plurality of error items is confirmed, an action according to the error item may be performed (S1430). In addition, if the error is confirmed in at least one error item of the plurality of error items, the error item may also be displayed.

Therefore, since the method for diagnosing the fault according to the present exemplary embodiment may confirm a variety of errors and faults related to the driving of the BLDC motor using feedback control factors used at the time of feedback control, it is possible to more appropriately protect the system. Therefore, there are advantages in that whether or not the fault of the motor system occurs may be confirmed, it is possible to determine whether the operation of the motor system is impossible by any cause such as the overload due to the faulty of the driven side, and it is possible to diagnose a detailed fault cause to quickly cope when an abnormal phenomenon occurs. The method for diagnosing the fault as illustrated in FIG. 14 may be executed on the image forming apparatus having the configuration of FIG. 1, may be executed on the motor controller having the configuration of FIG. 4, and may also be executed on the image forming apparatus or the motor controller having other configurations.

In addition, the method for diagnosing the fault as described above may be implemented in at least one execution program for executing the method for diagnosing the fault as described above, and the execution program may be stored in a computer readable recording medium.

A non-transitory computer readable medium does not mean a medium that stores data for a short period such as a register, a cache, a memory, or the like, but means a machine readable medium that semi-permanently stores the data. Specifically, various applications or programs described above may be provided to be stored in the non-transitory computer readable medium such as a compact disc (CD), a digital versatile disk (DVD), a hard disk, a Blu-ray disk, a universal serial bus (USB), a memory card, a read-only memory (ROM), or the like.

Hereinabove, the exemplary embodiments of the present disclosure have been illustrated and described, but the present disclosure is not limited to the above-mentioned exemplary embodiments and may be variously modified by those skilled in the art to which the present disclosure pertains without departing from the gist of the present disclosure as defined by the following claims. In addition, these modifications are within the scope of the following claims.

What is claimed is:

1. An image forming apparatus comprising:
an image former configured to perform an image formation;
a brushless DC (BLDC) motor which is driven to operate the image former to perform the image formation; and
a motor controller configured to:
obtain a plurality of driving information regarding the driving of the BLDC motor,
perform a feedback control for the driving of the BLDC motor based on at least one of the plurality of obtained driving information, and
determine whether at least one error item among a plurality of error items for the BLDC motor occurred, based on the plurality of obtained driving information.

2. The image forming apparatus as claimed in claim 1, wherein the plurality of the error items include at least one of an over-current error, an overload error, a current sensing error, a hall sensor error, and an FG error.

3. The image forming apparatus as claimed in claim 1, wherein:
the motor controller is further configured to:
obtain the plurality of driving information by sensing three-phase current values output from the BLDC motor, and
determine whether the at least one error item among the plurality of error items occurred by determining whether an over-current error occurred based on the sensed three-phase current values.

4. The image forming apparatus as claimed in claim 1, wherein:
the motor controller is further configured to:
obtain the plurality of driving information by sensing three-phase current values output from the BLDC motor,
calculate a torque value of the BLDC motor using the sensed three-phase current values, and
determine whether the at least one error item among the plurality of error items for the BLDC motor occurred by determining whether an overload error occurred based on the calculated torque value.

5. The image forming apparatus as claimed in claim 4, wherein the motor controller is further configured to determine whether the overload error occurred by:
determining whether a hall sensor error and an FG error occurred, and
determining that the overload error did not occur when it is determined that the hall sensor error and the FG error did not occur.

6. The image forming apparatus as claimed in claim 1, wherein:
the motor controller is further configured to:
obtain the plurality of driving information by sensing three-phase current values output from the BLDC motor,
calculate a current offset value from the sensed three-phase current values, and
determine whether the at least one error item among the plurality of error items for the BLDC motor occurred by determining whether a current sensing error occurred based on the calculated offset value.

7. The image forming apparatus as claimed in claim 1, wherein:
the motor controller is further configured to:
obtain the plurality of driving information by obtaining signal values of a hall sensor of the BLDC motor, and
determine whether the hall sensor error occurred based on whether the sensed signal values of the hall sensor have an abnormal combination value.

8. The image forming apparatus as claimed in claim 1, wherein:
the motor controller is further configured to:
obtain the plurality of driving information by obtaining signal values of a hall sensor of the BLDC motor and a value of an FG sensor of the BLDC motor, and
determine whether the at least one error item among the plurality of error items for the BLDC motor occurred by determining whether an FG sensor error occurred based on the sensed signal values of the hall sensor and the sensed value of the FG sensor.

9. The image forming apparatus as claimed in claim 1, wherein the motor controller is further configured to stop the driving of the BLDC motor, in response to it being determined that the at least one error item among the plurality of error items for the BLDC motor occurred.

10. The image forming apparatus as claimed in claim 1, wherein the motor controller is further configured to stop the driving of the BLDC motor, in response to it being determined that the at least one error item among the plurality of error items for the BLDC motor repeatedly occurred over a predetermined number of times for the same at least one error item.

11. The image forming apparatus as claimed in claim 1, further comprising a display configured to display the at least one error item, in response to it being determining that the at least one error item among the plurality of error items for the BLDC motor occurred.

12. The image forming apparatus as claimed in claim 1, wherein the motor controller includes:
an inverter configured to provide three-phase voltages to the BLDC motor;
a sensor configured to obtain the plurality of driving information regarding the driving of the BLDC motor; and
at least one processor configured to:
perform the feedback control for the driving of the BLDC motor based on at least one of the plurality of obtained driving information, and
determine whether the at least one error item among the plurality of error items for the BLDC motor occurred based on the plurality of obtained driving information.

13. The image forming apparatus as claimed in claim 12, wherein the sensor includes:
a rotor position sensor configured to obtain position information of the rotor from a hall sensor attached to the BLDC motor;
a speed sensor configured to obtain rotational speed information from the BLDC motor; and
a current sensor configured to sense a phase current of the BLDC motor.

14. The image forming apparatus as claimed in claim 1, further comprising:
a step motor; and
a DC motor,
wherein the motor controller further configured to control at least one of the step motor and the DC motor while the motor controller performs the feedback control for the driving of the BLDC motor.

15. A motor controller to control driving of a brushless DC (BLDC) motor, the motor controller comprising:
an inverter configured to provide three-phase voltages to the BLDC motor;
a sensor configured to obtain a plurality of driving information regarding the driving of the BLDC motor; and
a processor configured to:
perform a feedback control for the driving of the BLDC motor based on at least one of the plurality of obtained driving information, and
determine whether at least one error item among a plurality of error items for the BLDC motor occurred, based on the plurality of obtained driving information.

16. A method for controlling a brushless DC (BLDC) motor, the method comprising:
driving the BLDC motor by providing phase voltages to the BLDC motor;
obtaining a plurality of driving information regarding the driving of the BLDC motor; and
determining whether at least one error item among a plurality of error items for the BLDC motor occurred, based on the plurality of obtained driving information.

17. The method as claimed in claim 16, wherein the plurality of the error items include at least one of an over-current error, an overload error, a current sensing error, a hall sensor error, and an FG error.

18. The method as claimed in claim 16, wherein:
the obtaining the plurality of driving information comprises sensing three-phase current values output from the BLDC motor,
the determining whether the at least one error item among the plurality of error items for the BLDC motor occurred comprises:
calculating a torque value of the BLDC motor using the sensed three-phase current values, and
determining whether an overload error occurred based on the calculated torque value.

19. The method as claimed in claim 18, wherein the determining whether the at least one error item among the plurality of error items for the BLDC motor occurred further comprises determining that the overload error did not occur when the hall sensor error and the FG error did not occur.

20. The method as claimed in claim 16, further comprising displaying the at least one error item, in response to it being determined that the at least one error item among the plurality of error items for the BLDC motor occurred.
